(19) United States
(12) Patent Application Publication
(10) Pub. No.: US 2025/0185735 A1
(43) Pub. Date: Jun. 12, 2025

(54) LATTICE STRUCTURE INSERTS FOR SPORTS EQUIPMENT

(71) Applicants: Tara Singleton, Edmonton (CA); John Sexsmith, Edmonton (CA)

(72) Inventors: Tara Singleton, Edmonton (CA); John Sexsmith, Edmonton (CA)

(21) Appl. No.: 18/530,350

(22) Filed: Dec. 6, 2023

(51) Int. Cl. A41D 13/05; A41D 13/06; A41D 13/11; B33Y 80/00

(52) U.S. Cl. CPC A41D 13/0512; A41D 13/0518; A41D 13/0543; A41D 13/06; A41D 13/11; B33Y 80/00; C09J 7/26

(57) ABSTRACT

An insert for sports equipment includes a 3D-printed lattice structure comprising at least one lattice layer designed using computer aided design software and customized according to user preference as to at least one of a size, shape, a thickness and a density of the at least one lattice layer. In some embodiments, the insert further comprises a base layer and/or a backing layer. The insert provides customizable protection, mobility and comfort to the sports equipment to be used in consumer pre-owned sports equipment; or in the process of manufacturing new sports equipment—for example, if a manufacturer chooses to deviate from their traditional/original materials and replaces them with 3D printed components (the insert).

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of protective sports equipment of existing art and more specifically relates to inserts including lattice structures constructed via additive manufacturing.

### RELATED ART

Protective sports equipment and devices typically consist of components made up of multiple layers, incorporating a combination of materials like high-density foam, durable textiles, rigid plastic and leather to provide protection and shock absorption in relation to those worn by persons participating in high impact activities. For example; goalkeepers protective equipment plays a vital role in safeguarding against potential injuries and are crucial components of a goalie's protective gear such as goalkeeper masks, chest protectors, gloves, leg pads, knee guards, blockers, etc.

Despite their importance in providing protection, the current construction of these protective devices can present challenges. The use of foam, plastic, and leather has limitations in terms of shock absorption and weight distribution. For example, foam can lose its shock-absorbing capabilities over time, potentially compromising the device's protective function. Plastic, while providing structural reinforcement, can be rigid and may be uncomfortable for the goalkeeper creating undesired results of transmitting force causing injury. Leather, although durable and generally comfortable, may not offer optimal shock absorption.

Additive manufacturing, often referred to as 3D printing, is a manufacturing technique that builds three-dimensional objects layer by layer based on a digital model. The process starts with 3D computer-aided design (CAD) generating and exporting an output file of data in the form a STL (Stereolithography (or Standard Tessellation Language) which serves as an interface between 3D design and 3D printer. Various materials can be used in additive manufacturing, enabling the production of a wide array of components and is highly customizable.

Accordingly, there exists a need for a solution that utilizes the ease and customizability of additive manufacturing to overcome problems inherent in the known existing protective sports equipment art.

### SUMMARY OF THE INVENTION

In view of the foregoing disadvantages inherent in the known protective sports equipment art, the present disclosure provides novel lattice structure inserts for sports equipment. The general purpose of the present disclosure, which will be described subsequently in greater detail, is to provide a customizable 3D-printed lattice structure insert that is able to be inserted into sports equipment to replace existing protection and shock absorption materials within the sports equipment. Particularly, shape, size and density of the 3D-printed lattice structure insert is customizable.

An insert for sports equipment is disclosed herein. In some embodiments, the insert for sports equipment may include at least one layer of a lattice structure including at least one lattice layer designed using computer aided design software and customized according to user preference as to at least one of a size, shape, a thickness and a density of the at least one lattice layer. The lattice structure is subsequently formed by 3D-printing the at least one lattice layer, forming a 3D printed lattice structure. The insert may then be insertable into at least a portion of the sports equipment. In some embodiments, the insert for sports equipment may include variations of 3D printed structures and lattice sub-structures.

Further, in some embodiments, the insert for sports equipment may include a base layer. The base layer may (or may not) include a front surface having a first adhesive thereon and an opposite rear surface having a second adhesive thereon. A backing layer may (or may not) be attached over the second adhesive at the rear surface of the base layer and may (or may not) provide a temporary removable backing for the second adhesive. The 3D-printed lattice structure may (or may not) be adhered to the front surface of the base layer and may comprise at least one lattice layer.

According to another embodiment, the insert may include a 3D-printed base layer having a front surface primed with an adhesive material and an opposite rear surface including an adhesive strip. A 3D-printed lattice structure may be adhered to the front surface of the base layer and may comprise a plurality of lattice layers defining a three-dimensional network of repeating and non-repeating unique nodes interconnected by beams and defining voids therebetween. A backing layer may be attached over the adhesive strip on the rear surface of the base layer and may provide a temporary removable backing for the adhesive strip.

According to another embodiment, a method of producing an insert for sports equipment is also disclosed herein. The method may comprise the steps of: designing, via computer-aided design software, at least one lattice layer according to user preference as to at least one of a size, shape, a thickness and a density of the at least one lattice layer; selecting a desired material for the at least one lattice layer based on a desired result of the insert; exporting design data in a file format readable by a 3d printer; printing, by the 3D printer, the at least one lattice layer, forming a 3D printed lattice structure and thereby producing the insert. In some embodiments, the 3D-printed lattice structure may be used solo. In other embodiments it may adhered to the base layer. As such, the method may also include the step of adhering the 3D-printed lattice structure to the front surface of the base layer.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, lattice structure inserts for sports equipment, constructed and operative according to the teachings of the present disclosure.

FIG. 1 is a flow diagram illustrating a method of producing an insert for sports equipment, according to an embodiment of the present disclosure.

FIG. 2 is a flow diagram illustrating the method of producing the insert for sports equipment, according to another embodiment of the present disclosure.

FIG. 3 is a plan view of an example lattice structure, according to an embodiment of the disclosure.

FIG. 4 is a perspective view of the example lattice structure of FIG. 3, according to an embodiment of the disclosure.

FIG. 5 is a plan view of another example lattice structure, according to an embodiment of the disclosure.

FIG. 6 is a perspective view of the another example lattice structure of FIG. 5, according to an embodiment of the disclosure.

FIG. 7 is a cross-section view of an insert attached to a piece of sports equipment, according to an embodiment of the disclosure.

FIG. 8 is a cross-section view of the insert enclosed inside the piece of sports equipment, according to an embodiment of the disclosure.

FIG. 9 is a cross-section view of the insert including a lattice structure, a base layer and a backing layer, according to an embodiment of the disclosure.

FIG. 10A is a top perspective view of a plurality of base layers, according to an embodiment of the disclosure.

FIG. 10B is a top perspective view of a hockey goalkeeper glove portion mapped onto a base layer for cutting the base layer to the hockey goalkeeper glove portion size, according to an embodiment of the disclosure.

FIG. 10C is a plan view of a lattice structure to be cut to a desired size, according to an embodiment of the disclosure.

FIG. 10D is a plan view illustrating a backing layer and pull tab, according to an embodiment of the disclosure.

FIG. 10E is a plan view of lattice structures attached to the base layer, according to an embodiment of the disclosure.

FIG. 10F is a top perspective view of lattice structures attached to the hockey goalkeeper glove, according to an embodiment of the disclosure.

FIG. 11 is an exploded perspective view of the lattice structures and the base layer, according to an embodiment of the disclosure.

FIG. 12 is a top perspective view of a plurality of lattice structures attached to an interior of a hockey goalkeeper glove that has been deconstructed, according to an embodiment of the disclosure.

FIG. 13 is a top perspective view of the interior of the deconstructed hockey goalkeeper glove, according to an embodiment of the disclosure.

FIG. 14 is a plan view of a top side of a palm/finger insert, according to an embodiment of the disclosure.

FIG. 15 is a plan view of a bottom side of the palm/finger insert, according to an embodiment of the disclosure.

FIG. 16 is a plan view of a top side of a palm/finger insert, according to an embodiment of the disclosure.

FIG. 17 is a plan view of a top side of a cuff insert, according to an embodiment of the disclosure.

FIG. 18 is a partial cutaway view of a goalkeeper blocker including the lattice structure therein, according to an embodiment of the disclosure.

FIG. 19 is a plan view of a pair of base layers, according to an embodiment of the disclosure.

FIG. 20 is a top perspective view of the pair of base layers, according to an embodiment of the disclosure.

FIG. 21 is a top perspective view of the pair of base layers being connected together, according to an embodiment of the disclosure.

FIG. 22 is a plan view of the pair of base layers connected together, with one of the base layers removed to illustrate an interior of the connected together layers, according to an embodiment of the disclosure.

FIG. 23 is a top perspective view of the pair of base layers connected together, with one of the base layers removed to illustrate an interior of the connected together layers, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to lattice structure inserts for sports equipment. Generally, the present disclosure relates to protective inserts for (in some examples) ice hockey goalkeeper equipment that are made up of a lattice structure to use in place of traditional foam and plastic elements of ice hockey protective equipment. The lattice structure is designed with CAD (computer aided design software) and manufactured through 3D printing, utilizing additive manufacturing techniques that weave a three-dimensional network of repeating and non-repeating unique nodes interconnected by beams, resulting in custom-tailored performance improvements and protective features aligned with specific desired objectives.

In some embodiments, a base layer of the protective insert may be provided in different sizes and shapes to accommodate the different designs used in the already manufactured equipment and accessories (again, such as ice hockey goalkeeper equipment). The base layer may be constructed of a thin, flexible resin primed with adhesive to receive additional layers according to desired need. A rear side of the base layer may include a smooth finish with an adhesive strip covered with a backing that can be easily removed with a pull tab system once the insert has been fit into a desired position.

Different densities, thickness and lattice designs are mapped and layered together to build the desired result. Multiple layers of different densities and thickness can be used to achieve the desired balance of protection, mobility, and comfort. The arrangement and thickness of these layers can vary. The protective insert may be used in consumer pre-owned sports equipment; or in the process of manufacturing new sports equipment—for example, if a manufacturer chooses to deviate from their traditional/original materials and replaces them with 3D printed components (the protective insert).

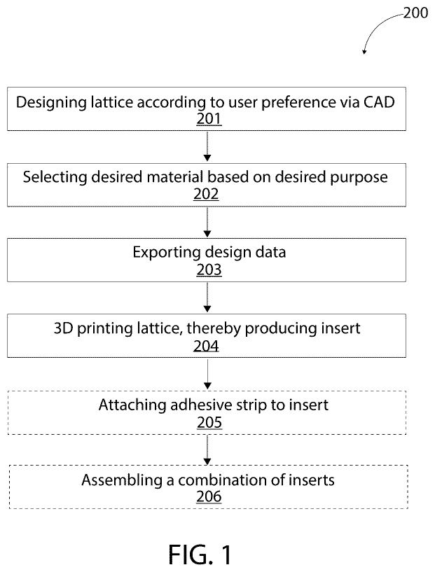

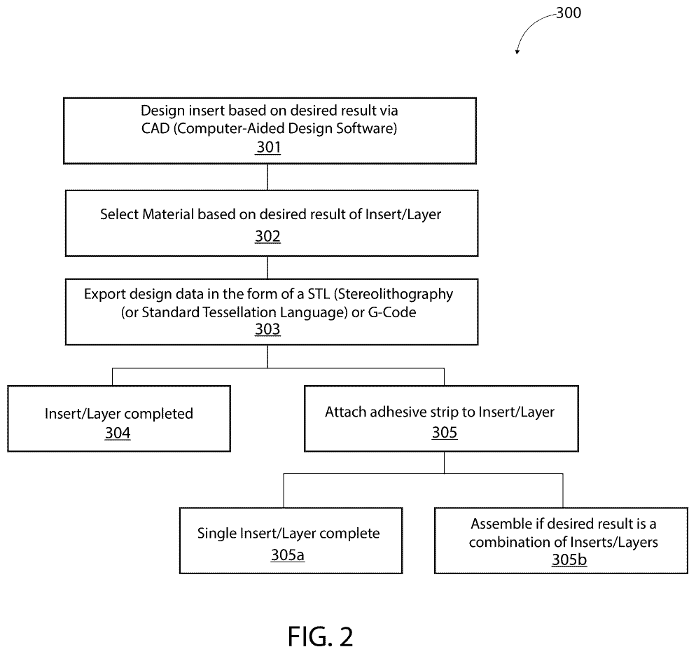

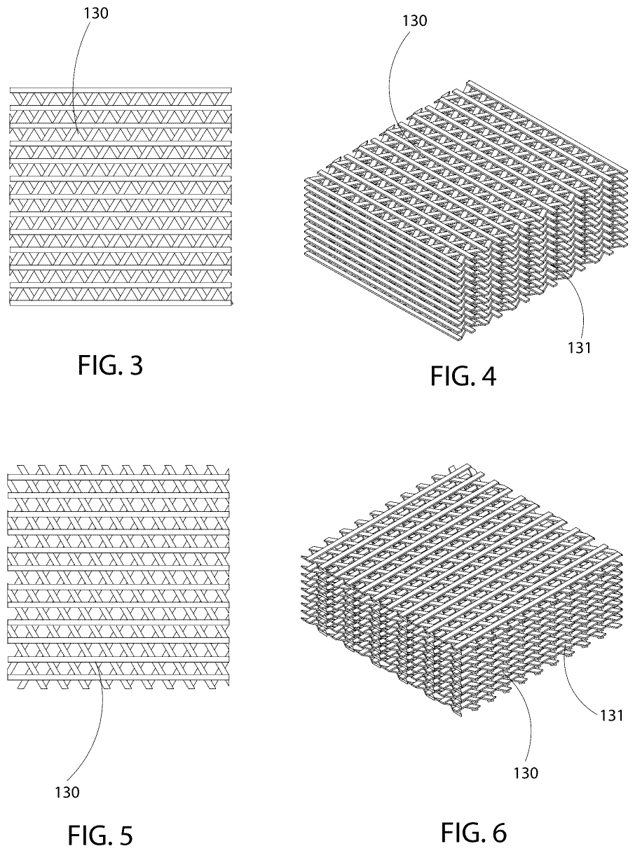

Referring now more specifically to the drawings by numerals of reference, there is shown in FIGS. 1-2 a method 200 of producing an insert for sports equipment and in FIGS. 3-23, various views of an insert 100 for sports equipment 5. It should be appreciated that the provided figures and discussion throughout provides just some examples of some applications to specific sports equipment and is not meant to limit the insert 100 to just these examples.

Referring first to FIGS. 1-2, there is shown flow diagrams illustrating the method 200 of producing an insert for sports equipment, according to an embodiment of the present disclosure. In particular, the method 200 may include one or more components or features of the insert 100.

As illustrated in FIG. 1, the method 200 may include the steps of: step one 201, designing, via computer-aided design software, at least one lattice layer according to user preference as to at least one of a size, shape, a thickness and a density of the at least one lattice layer; step two 202, selecting a desired material for the at least one lattice layer based on a desired result of the insert; step three 203, exporting design data (e.g., completed CAD design) in a file format readable by a 3d printer (e.g., stereolithography [or standard tessellation language], G-code, or the like); step four 204, printing, by the 3D printer, the at least one lattice layer, forming a 3D printed lattice structure and thereby producing the insert.

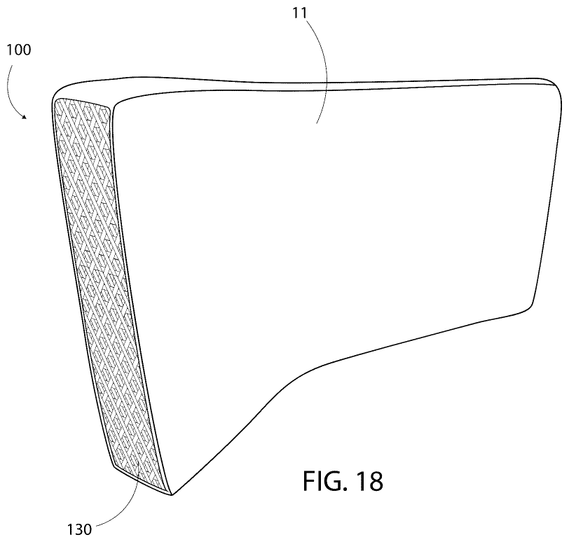

A further step may include: step five 205, attaching an adhesive strip to the insert, enabling the insert to adhere to at least a portion of the sports equipment. This step may only be performed for sports equipment requiring the insert to adhere to it. In sports equipment where the insert can be simply inserted into the sports equipment and held therein, adhesive may not be needed and therefore this step can be avoided (an example of this is shown in FIG. 18).

An additional step may include: step six 206, assembling a combination of inserts together, each of the inserts having been produced by repeating steps two to four (201, 202, 203, 204). In some embodiments, that will be discussed in further detail below, it may be desirable to combine inserts, to achieve a desired result.

In addition, normal steps known in the art to be taken in the additive manufacturing process may be incorporated herein. For example, curing steps may be taken after the 3D-printing, slicing/printer instruction providing steps may be taken prior to 3D-printing, and the like.

FIG. 2 demonstrates another embodiment of the steps in method 200 as discussed above. As shown here, step one 301, may include designing the insert based on desired result via Computer Aided Design Software (CAD); step two 302, may include selecting material based on desired result of the insert; step three 303, exporting design data in the form of a STL (stereolithography [or standard tessellation language]) or G-Code; and step four 304, completing the insert. For example, via 3D printing the insert.

Further steps may include step five 305, attaching an adhesive strip to the insert—at this point, the insert may be complete (305 a); or alternatively, if the desired results includes a combination of inserts, another step may include assembling 305 b a combination of inserts.

It should be noted that certain steps are optional and may not be implemented in all cases. Optional steps of method 200 are illustrated using broken lines in FIG. 1 so as to distinguish them from the other steps of method 200. It should also be noted that the steps described in the method 200 can be carried out in many different orders according to user preference. It should also be noted that, under appropriate circumstances, considering such issues as design preference, user preferences, marketing preferences, cost, structural requirements, available materials, technological advances, etc., other methods are taught herein.

Referring now to FIGS. 3-6, there are shown various views of example lattice structures 130 (FIGS. 3-6). as above, the lattice structure 130 may be designed and customized based on individual needs and objectives. Accordingly, there may be no limit to the configurations of each layer 131 (whether one or more) of the lattice structure 130. It should be appreciated that these configurations are provided as examples only and are not meant to limit the insert 100 in any way.

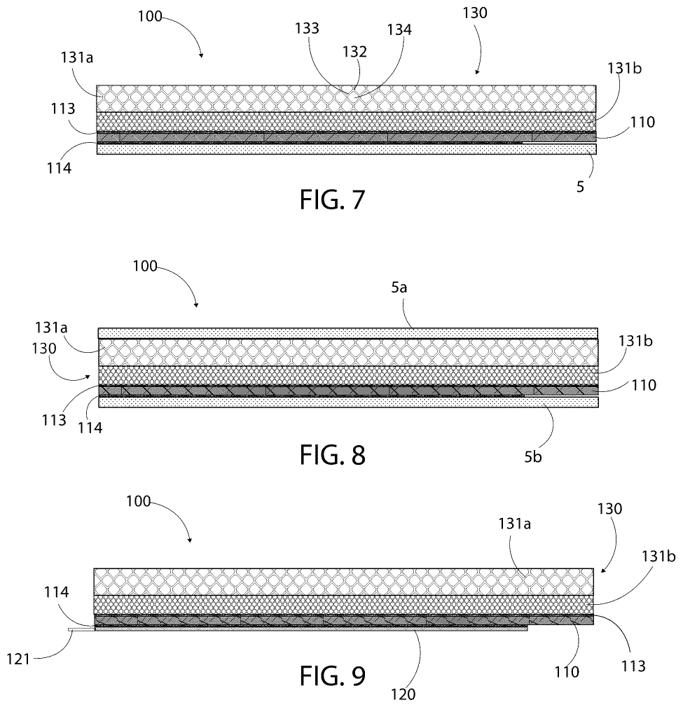

Referring to FIGS. 7-9, there are shown cross-sectional views of the insert 100, according to one or more embodiments of the present disclosure. Referring first to FIG. 7 there is illustrated a cross-section of an insert 100 attached to the sports equipment 5. FIG. 8 illustrates an insert 100 enclosed between a bottom side 5 b of the sports equipment 5 (the side the insert 100 is adhered to) and a top side 5 a (covering the insert 100, e.g., when the sports equipment 5 is put back together). Further, FIG. 9 illustrates the insert 100 prior to insertion into sports equipment 5.

As shown here in these figures, the 3D-printed lattice structure 130 may comprise at least one lattice layer 131. The 3D-printed lattice structure 130 may first be designed and engineered utilizing computer aided design software according to user preference as to a size, shape, a thickness and/or a density of the comprise at least one lattice layer 131. Once designed a material may be chosen based on a desired purpose for the insert 100. For example, the material may be chosen based on protection level needed, comfort level needed, mobility level needed, and the like.

Each layer 131 may be created to serve a particular purpose such as protection, mobility, comfort, and the like, based on user preference. Thickness, density, size, shape, pattern, etc. of each layer 131 may be chosen for the particular purpose, along with amount of layers, or thickness, of the overall 3D-printed lattice structure 130. As such, the designing of the 3D-printed lattice structure 130 may include mapping the thickness, density and pattern of each layer 131 of the lattice structure 130 to serve the particular desired purpose.

Densities of the 3D-printed lattice structure 130 may range from low to high density. For example, high density lattice structures 130 may be used in critical impact areas to provide maximum protection against high-velocity shots/impact. The high density lattice structure 130 absorbs and distributes impact energy effectively.

Medium density lattice structures 130 may be used in less critical impact areas, such as the arms and the legs. The medium density lattice structures 130 balance between protection and flexibility, allowing the user to move comfortably while still having impact resistance. Low density lattice structures 130 may be used in areas where flexibility and comfort are crucial, providing cushioning without sacrificing mobility.

FIGS. 7-8 illustrate a 3D-printed lattice structure 130 made up of two lattice layers 131 a, 131 b—the bottom layer 131 b in these figures is denser than the top layer 131 a. As shown in FIG. 3, each of the lattice layers 131 may define a three-dimensional network of repeating and non-repeating unique nodes 132 interconnected by beams 133 and defining voids 134 therebetween. The size, shape, thickness, arrangement, etc. of each of the nodes 132, beams 133 and voids 134 may be chosen for the particular purpose, as discussed above. For example, the smaller voids 134 in the bottom layer 131 b may provide more impact protection than the top layer top layer 131 a, while the larger voids 134 in the top layer 131 a may provide more movability and comfort.

It should be appreciated that the structure, arrangement, density, thickness, amount of layers, etc. shown throughout are given to provide examples and aid in understanding only, and do not limit the invention in any way.

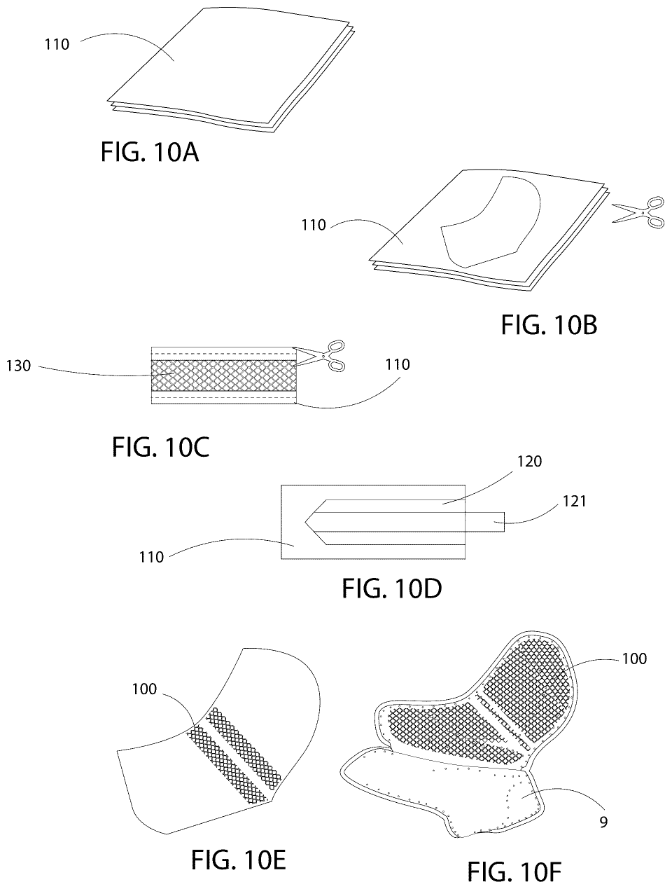

Referring now to FIGS. 10A-10F, there are various views of the insert 100 for sports equipment 5 and depicting various steps taken in using the insert 100, according to one or more embodiments of the present disclosure. Particularly, FIG. 10A depicts a plurality of base layers 110 that may be provided in a base size (such as small, medium and large), allowing a user to cut the base layer 110 to a size that accommodates the sports equipment 5 that the insert will be placed into. As shown in FIG. 10B, a portion of a hockey goalkeeper glove 9 has been mapped onto a base layer 110, enabling the user to then cut the base layer 110 to the size of the portion of the hockey goalkeeper glove 9.

At this point, in some embodiments, desired lattice structure(s) 130 may be chosen and trimmed to a desired size, as shown in FIG. 10C. As shown in FIG. 10D a backing layer 120 may then be removed to adhere the lattice structure 130 to the base layer 110, as shown in FIG. 10E. The base layer 110 may then be inserted, with various lattice structures 130 thereon, to protective sports equipment 5, or the hockey goalkeeper glove 9 as shown in FIG. 10F.

It should be appreciated that it is contemplated that the insert 100 includes at least one layer including the lattice structure 130, which itself may be made up of one or more lattice layers 131. Some embodiments of the insert 100 may include additional layers, such as the backing layer 120 and/or the base layer 110, but the insert 100 is not limited to including the backing layer 120 and/or the base layer 110.

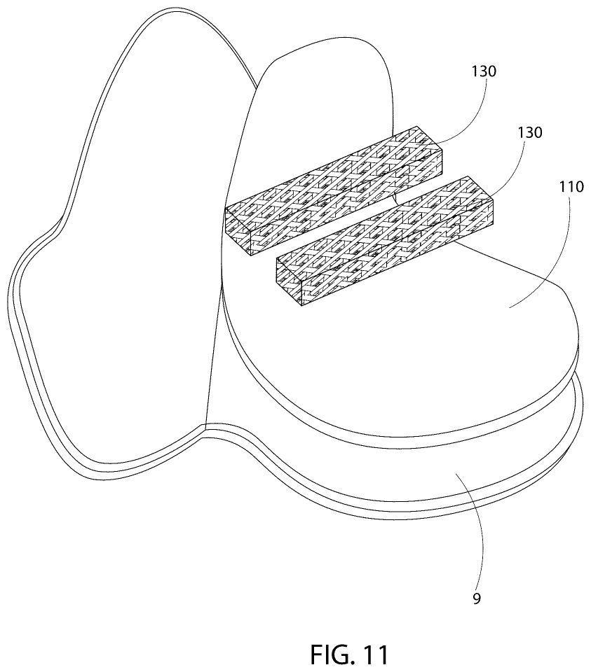

Referring now more specifically to FIGS. 11-18, there are shown various views of the insert 100 for sports equipment 5. Particularly, as above and as shown in these figures, the insert 100 may be particularly useful for ice hockey equipment, especially ice hockey goalkeeper equipment, as the insert 100 of the present invention is able to provide improved shock absorption and protection over previous inserts and padding in the art.

For example, the insert 100 may be contemplated for particular use in hockey goalkeeper gloves, hockey goalkeeper blockers, hockey goalkeeper leg pads, hockey goalkeeper chest protectors, jockstraps, hockey goalkeeper skate inserts, neck guards, hockey goalkeeper pants, knee guards, sweatbands, and hockey goalkeeper mask. It should however be appreciated that this list is not exhaustive. It should also be appreciated that the insert 100 is not limited to use with ice hockey equipment—it is contemplated that the insert 100 can be used with any equipment able to accept the insert 100 and used to provide protection, comfort and/or mobility.

As above, the insert 100 may particularly replace existing inserts and/or padding located in the equipment 5, such as foam and plastic. For example, FIGS. 11-13 demonstrate a hockey goalkeeper glove 9 that originally included foam, leather, plastic, etc. as the protective and shock absorbing elements. As such, a user may remove the foam, leather, plastic, etc. and replace it with one or more of the inserts 100 to provide customized and improved protection, shock absorption, comfort and mobility.

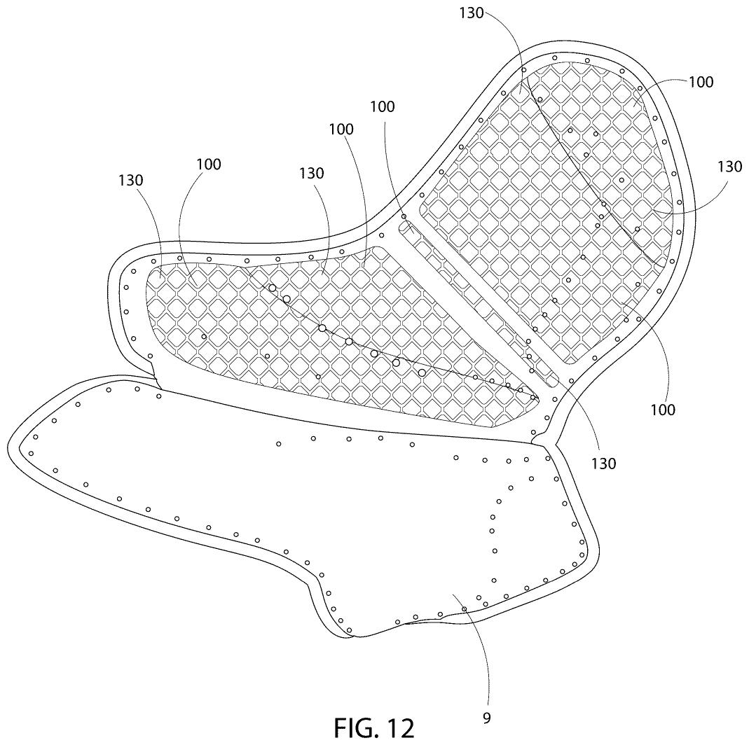

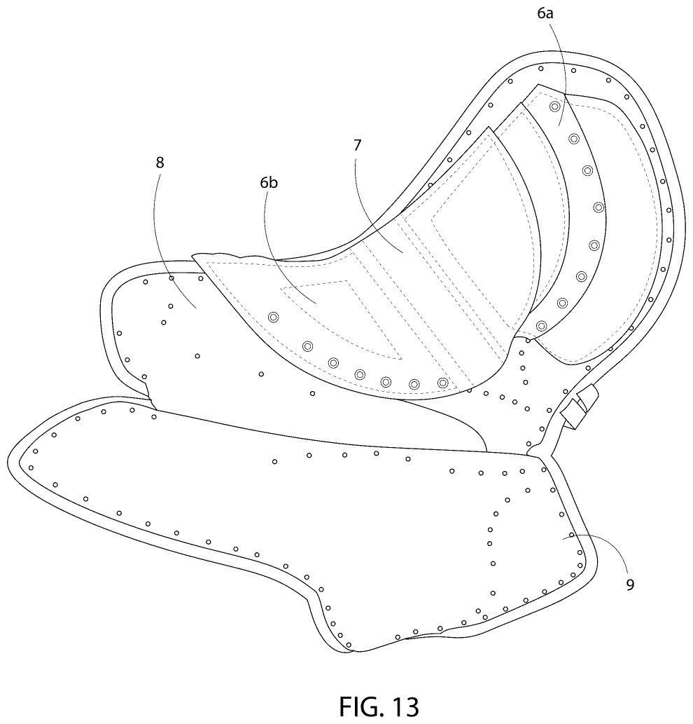

FIG. 11 demonstrates an exploded perspective view of a lattice structure 130 and a base layer 110 being inserted into the hockey goalkeeper glove 9. FIG. 12 demonstrates a perspective view of a plurality of lattices structures 130 inserted into the hockey goalkeeper glove 9 that has been deconstructed to remove previous inserts, padding, and/or other materials such as foam and plastic. FIG. 13 illustrates the deconstructed piece of sports equipment 5 in the existing prior art, without the inserts 100 inserted therein. Portions of the hockey goalkeeper glove 9 are referenced in order to aid in understanding of the present invention. For example, in FIG. 13, reference 6 a, 6 b illustrates finger/palm portions; reference 7 illustrates a center finger portion; and reference 8 illustrates a cuff portion.

FIGS. 11-12 particularly demonstrate 3D-printed lattice structures 130 of the insert 100. In some embodiments, each portion of the hockey goalkeeper glove 9 may receive different thicknesses, patterns (designs) and densities of the 3D-printed lattice structure 130. For example, the center finger portion 7 may receive an insert 100 having a 6-8 mm thick lattice structure 130. In another example, the palm/finger portion 6 may receive an insert 100 having a 10-12 mm thick lattice structure 130. It should be appreciated that the lattice structures 130 on these particular portions are not limited to the dimensions provided here, however.

Referring also now to FIGS. 14-17, there is shown plan views of a variety of inserts 100 a, 100 b, 100 c configured for application into different areas of the hockey goalkeeper glove 9. Particularly, the insert 100 may include a base layer 110 and a backing layer 120. The base layer 110 may include a front surface 111 opposite a rear surface 112. In some embodiments, the base layer 110 may include a thin flexible resin which can include different shapes and sizes to accommodate a variety of different items/equipment 5 to insert into. In some embodiments, the base layer 110 may be 3D-printed, along with the 3D-printed lattice structure 130.

The front surface 111 of the base layer 110 may include a first adhesive 113 thereon. For example, the first adhesive 113 may be (but is not limited to) a liquid adhesive used to prime the entire front surface 111 of the base layer 110. In some embodiments, the adhesive may be applied to the front surface 111 of the base layer 110 during the 3D-printing process (in embodiments where the base layer 110 is 3D-printed). In other embodiments, the adhesive may be applied after.

The rear surface 112 of the base layer 110 may preferably be smooth and include a second adhesive 114 thereon. This adhesive 114 may be different to the first adhesive 113. Particularly, the second adhesive 114 may include an adhesive strip 114. The adhesive strip 114 may enable the insert 100 to adhere to the sports equipment 5 that the insert 100 is being inserted into.

The backing layer 120 provides a temporary removable backing for the adhesive strip 114, thereby protecting the adhesive quality of the adhesive strip 114, preventing the adhesive strip 114 from inadvertently sticking to other surfaces and aiding in application of the insert 100. When desired, the backing layer 120 may be easily removed from the rear surface 112 of the base layer 110. Particularly, the backing layer 120 may include a pull tab 121 that is graspable by a user to aid in peeling of the backing layer 120 from the adhesive strip 114. As such, in use, a user may place the insert 100 in a desired position in the sports equipment 5, grasp the pull tab 121 and pull, peeling the backing layer 120 from the adhesive strip 114 to adhere the insert 100 to the sports equipment 5.

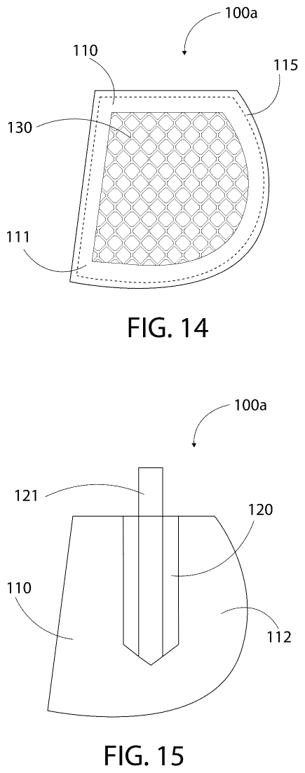

Referring now to FIGS. 14-15, there is shown a palm/finger insert 100 a. The palm/finger insert 100 a may be provided in left and right versions for left and right glove, respectively. FIG. 14 illustrates a front side of the palm/finger insert 100 a. As shown here, the front side may include the 3D-printed lattice structure 130 adhered to the front surface 111 of the base layer 110 and a cut/trim line 115 disposed on the base layer 110. In some embodiments, the 3D-printed lattice structure 130 may include a thickness of between 10-12 mm. Preferably, the 3D-printed lattice structure 130 may be provided in three different thicknesses.

FIG. 15 illustrates a rear side of the palm/finger insert 100 a. As shown here, the rear side may include the base layer 110, the adhesive strip 114, the backing layer 120 and the pull tab 121. The remaining portion of the base layer 110 may not include any adhesive and may include a 3D-printed smooth finish to allow for easy insertion and minimal disassembly of the glove 9.

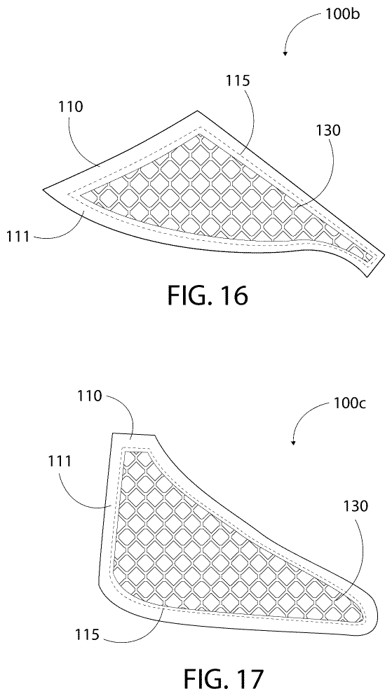

FIG. 16 illustrates a front side of a palm/finger insert 100 b according to another embodiment of the present disclosure. Again, the front side of the palm/finger insert 100 b may include a 3D-printed lattice structure 130 having a thickness of between 10-12 mm.

FIG. 17 illustrates a front side of a cuff insert 100 c. As shown here, the front side may include the 3D-printed lattice structure 130 adhered to the front surface 111 of the base layer 110 and a cut/trim line 115 disposed on the base layer 110. In some embodiments, the 3D-printed lattice structure 130 may include a thickness of between 6-8 mm. It is contemplated that a rear side of the cuff insert 100 d include the same elements as the palm/finger insert 100 c and the center finger insert 100 a, 100 b as discussed above and as such, illustration is omitted.

Referring now to FIG. 18, there is shown a partial cutaway view illustrating a hockey goalkeeper blocker 11, according to one or more embodiments of the present disclosure. As shown here, an interior of the hockey goalkeeper blocker 11 has been replaced with the insert 100 of the present invention. Particularly shown here is the 3D-printed lattice structure 130. As above, the insert 100 may be inserted into existing sports equipment 5. In this embodiment, an interior of the hockey goalkeeper blocker 11 may have initially included foam. As such, a user may remove the foam within the hockey goalkeeper blocker 11 and insert the insert 100 into the hockey goalkeeper blocker 11 to replace the foam and provide improved shock absorption and protection with the 3D-printed lattice structure 130. In this example, the insert 100 may not include any adhesive (such as the adhesive strip 114), as the insert 100 is able to be inserted into and contained directly within the hockey goalkeeper blocker 11.

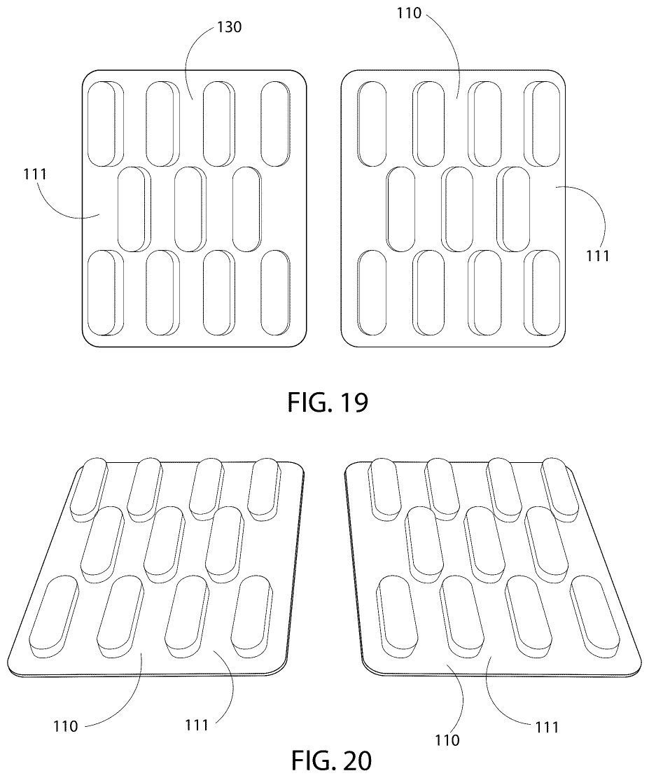

FIGS. 19-23 illustrate an example embodiment of the base layer 110 according to one or more embodiments of the present disclosure. In some embodiments, as above, the base layer 110 may also be designed and engineered utilizing computer aided design and 3D-printed. The base layer 110 may be provided in a variety of sizes and shapes and combined with the 3D-printed lattice structure 130. The base layer 110 may be combined with the 3D-printed lattice structure 130 during the additive manufacturing process, or after the additive manufacturing process.

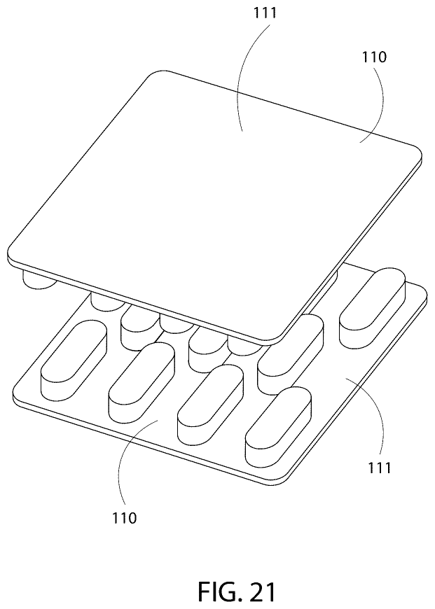

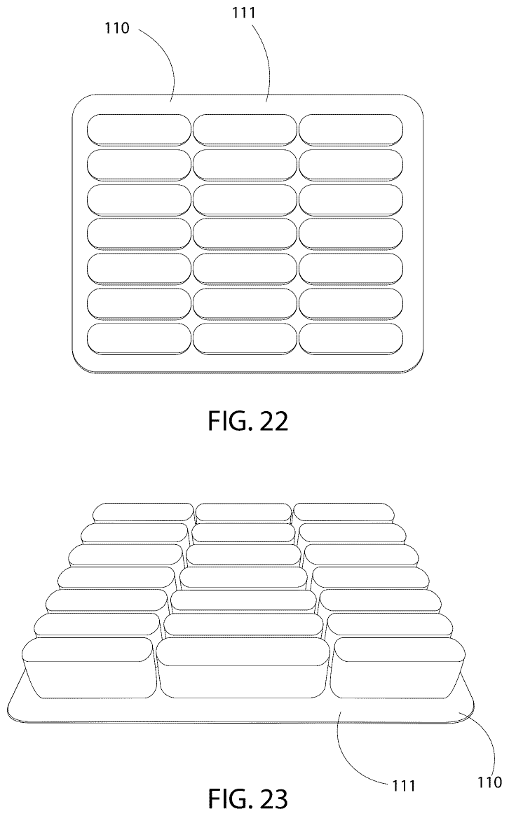

The base layer 110 may be provided in two matching pairs 110 a, 110 b, as shown in FIGS. 19-20, that are configured to be connected together—as demonstrated in FIG. 21. FIGS. 22-23 show the two matching pairs 110 a, 110 b attached together with one of the layers removed to show an interior of the connected matching pairs 110 a, 110 b. The two matching pairs 110 a, 110 b may be provided in predetermined sizes that are able to be customized (i.e., cut) by the user to suitably accommodate the sports equipment 5.

Those with ordinary skill in the art will now appreciate that upon reading this specification and by their understanding the art of additive manufacturing as described herein, methods of designing, engineering and manufacturing 3D-printed structures, particularly lattice structures, will be understood by those knowledgeable in such art.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

What is claimed is:

1. An insert for sports equipment, the insert comprising:
at least one layer including:
a lattice structure including at least one lattice layer designed using computer aided design software and customized according to user preference as to at least one of a size, shape, a thickness and a density of the at least one lattice layer, the lattice structure subsequently formed by 3D-printing the at least one lattice layer; and
wherein the insert is insertable into at least a portion of the sports equipment.

2. The insert of claim 1, further comprising a base layer having a front surface opposite a rear surface.

3. The insert of claim 2, wherein the front surface includes a first adhesive.

4. The insert of claim 3, wherein the rear surface includes a second adhesive.

5. The insert of claim 4, wherein the lattice structure is adhered to the front surface of the base layer.

6. The insert of claim 5, further comprising a backing layer attached over the second adhesive at the rear surface of the base layer, the backing layer providing a temporary removable backing for the second adhesive.

7. The insert of claim 6, wherein the lattice structure comprises a plurality of lattice layers each designed using computer aided design software and customized according to user preference as to at least one of said size, said shape, said thickness and said density.

8. The insert of claim 7, wherein the base layer is a thin flexible resin.

9. The insert of claim 8, wherein the base layer is 3D-printed.

10. The insert of claim 9, wherein the backing layer includes a pull tab to enable a user to manually peel the backing layer from the insert.

11. An insert for sports equipment, the insert comprising:
a base layer having a front surface opposite a rear surface, the front surface primed with an adhesive material; and
a lattice structure configured to adhere to the front surface of the base layer, the lattice structure including at least one lattice layer designed using computer aided design software and customized according to user preference as to at least one of a size, shape, a thickness and a density of the at least one lattice layer, the lattice structure subsequently formed by 3D-printing the at least one lattice layer; and
wherein the insert is insertable into at least a portion of the sports equipment.

12. The insert of claim 11, wherein the rear surface includes a second adhesive.

13. The insert of claim 12, further comprising a backing layer attached over the second adhesive at the rear surface of the base layer, the backing layer providing a temporary removable backing for the second adhesive.

14. The insert of claim 13, wherein the 3D-printed lattice structure comprises a plurality of lattice layers each designed using computer aided design software and customized according to user preference as to at least one of said size, said shape, said thickness and said density.

15. The insert of claim 14, wherein the base layer is a thin flexible resin.

16. The insert of claim 15, wherein the base layer is 3D-printed.

17. The insert of claim 16, wherein the backing layer includes a pull tab to enable a user to manually peel the backing layer from the insert.

18. A method of producing an insert for sports equipment, the method comprising:
designing, via computer-aided design software, at least one lattice layer according to user preference as to at least one of a size, shape, a thickness and a density of the at least one lattice layer;
selecting a desired material for the at least one lattice layer based on a desired result of the insert;
exporting design data in a file format readable by a 3d printer; and
printing, by the 3D printer, the at least one lattice layer, forming a 3D printed lattice structure and thereby producing the insert.

19. The method of claim 18, further comprising the step of:
attaching an adhesive strip to the insert, enabling the insert to adhere to at least a portion of the sports equipment.

20. The method of claim 19, further comprising the steps of:
assembling a combination of inserts together, each of the inserts having been produced by repeating the steps in claim 18.
